(19) United States
(12) Patent Application Publication
(10) Pub. No.: US 2023/0258027 A1
(43) Pub. Date: Aug. 17, 2023

(54) SINGLE USE HARD TAG

(71) Applicant: CHECKPOINT SYSTEMS, INC., Thorofare, NJ (US)

(72) Inventors: Irene Fernandez Camín, Barcelona (ES); Joan Sushil Flores CUBERES, Barcelona (ES)

(21) Appl. No.: 17/798,098

(22) PCT Filed: Feb. 16, 2021
(86) PCT No.: PCT/US2021/018143

§ 371 Date: Aug. 8, 2022

(51) Int. Cl. E05B 73/00; E05B 15/16; G08B 13/24

(52) U.S. Cl. CPC E05B 73/0017; E05B 15/16; G08B 13/2434; G08B 13/2417

(57) ABSTRACT

Provided is a single use hard tag. In an embodiment, the single use hard tag may be removable by the consumer after purchase and prior to wear. In an embodiment, components of the single use hard tag are soluble, biodegradable, or otherwise recyclable. For example, a portion of the single use hard tag may be water soluble under certain conditions. In an example, the entire single use hard tag may be water soluble under certain conditions. The single use hard tag may be removable by a release point on the pin at the base, wherein the pin remains locked in locking mechanism even after removal.

### CROSS REFERENCE TO RELATED APPLICATIONS

This application claims priority to U.S. Provisional Patent Application No. 62/976,678 entitled “SINGLE USE HARD TAG” filed on Feb. 14, 2020 which is hereby incorporated herein by reference in its entirety.

### TECHNICAL FIELD

The present disclosure relates to loss prevention and merchandise preservation technologies and, more particularly, to single use, removable hard tags that are at least partly soluble.

### BACKGROUND

Retail stores may employ various loss prevention techniques to prevent and deter theft of merchandise, including radio frequency identification (RFID) tags and electronic article surveillance (EAS) systems that track inventory and/or alarm under specified conditions likely to be associated with an attempted theft before a point of sale. In some applications, the hard tag may be removed at purchase by a specialized tool. In other applications, it may be desirable to have a hard tag attached to merchandise after sale that is removable by a consumer and that indicates whether an item has been worn. For example, the consumer may only be able to wear an item after removal of the hard tag and returns may be limited only to merchandise still bearing the hard tag.

Unlike hard tags that may be removed in store and reused on different merchandise, a hard tag removed by the consumer after purchase may be single use or may rely on consumer-driven recycling programs. As a result, there is a need for a sustainable and biodegradable hard tag that may limit the use of plastic or other non-sustainable materials. There is also a need for a hard tag that may be easily and safely removed by a consumer without a specialized tool, while still being able to effectively secure to merchandise prior to intended removal.

### SUMMARY

Disclosed is a single use hard tag that is removable by the consumer after purchase and prior to wear. In an embodiment, one or more components of the single use hard tag are soluble, biodegradable, or otherwise recyclable. For example, a portion of the single use hard tag may be water soluble under certain conditions. In an example, the entire single use hard tag may be water soluble under certain conditions. The single use hard tag may be removable by a release point on the pin at the base, wherein the pin remains locked in the locking mechanism even after removal.

The solubility or biodegradability of the single use hard tag or components thereof may allow for an ecofriendly tag alternative as compared to single use hard tags that are not soluble or do not biodegrade over time and, as a result, create plastic waste and accumulate in a landfill. Additionally, the solubility or biodegradability of certain components of the single use hard tag may enable reuse of any components that are not be soluble or biodegradable. In an example, any irreversible mechanism of the single use hard tag, (e.g. a releasable pin, a base from which the pin is released, or lock which the pin is released into) which cannot easily or desirably be reused and would thereby end up being discarded, may be made of a soluble or biodegradable material. Any portions of the single use hard tag which do not sustain irreversible use (e.g. cap, housing, some components of the locking mechanism) may also be made of a soluble or biodegradable material or these portions can be recycled and repurposed with a new soluble or biodegradable mechanism (e.g. a base where a pin is still releasably attached thereto). In an embodiment, it may be desirable to include an irreversible aspect of a locking mechanism to ensure that any tag that is removed by a consumer, for example, is removed irreversibly so that the tag cannot be improperly reattached by a consumer. In an effort to minimize waste or streamline reuse of tags, it may also be desirable to make the tags, portions thereof, and, as an example, any portions that are “single use” (i.e. irreversible in their use) soluble or biodegradable.

Disclosed is a security device. In an embodiment, the security device may comprise a tag. In an embodiment, the tag may comprise a first body. The first body may be engageable with a second body via a locking mechanism. In an embodiment, at least one of the first body, second body, a part of the locking mechanism, or the whole locking mechanism may be formed from a soluble or biodegradable material. In an embodiment, the locking mechanism may comprise a pin and locking insert configured to receive the pin. The locking insert may comprise a receiving cavity. The locking mechanism may be formed from material that is not soluble or biodegradable. The locking mechanism may be formed from a soluble or biodegradable material. In an embodiment, the locking mechanism may comprise a locking sled. The locking sled may be formed from a soluble or biodegradable material. It is noted that any combination of the first body, second body, a part of the locking mechanism (or part of the lock thereof) may be formed from a soluble or biodegradable material.

In an embodiment, the soluble or biodegradable material may be a water soluble material. The water soluble material may be one or more materials selected from polyvinyl alcohol; acetylated polyvinyl alcohol; polyvinylpyrrolidone; polyethylene oxide; gelatin, sulfate-, carbonate-, and/or citrate-substituted polyvinyl alcohols, polyvinylpyrrolidones, polyalkylene oxides, acrylamides, cellulose esters, cellulose ethers, cellulose amides, cellulose and derivatives thereof (such as hydroxypropyl methylcellulose), polyvinyl acetates, polycarboxylic acids and salts thereof, polyamino acids or peptides, polyamides, polyacrylamides, copolymers of maleic acid and acrylic acid, copolymers of acrylamides and (meth)acrylic acid, polysaccharides, or a combination of two or more thereof. In an embodiment, the water soluble material may be soluble in water having a temperature of from about 5° C. to about 100° C. In an embodiment, the water soluble material may be soluble in water having a temperature of from about 5° C. to about 15° C. In and embodiment, the water soluble material may be soluble in water having a temperature of from about 20° C. to about 25° C. In an embodiment, the water soluble material may be soluble in water having a temperature of from about 50° C. to about 70° C. In an embodiment, the security device may further comprise one or more of a radio frequency identification device or electronic article surveillance system.

Disclosed is a single use, water soluble hard tag. In an embodiment, the single use, water soluble hard tag may comprise a housing enclosing a hollow cavity, a base, and a lock (or lock insert), wherein the lock may be positioned in the hollow cavity and operatively configured to receive and secure a pin and wherein the pin may be releasably attached to the base. In an embodiment, one or more of the housing, the base, the pin, or the lock may be formed from a soluble or biodegradable material. In an embodiment, the pin may be formed from a soluble or biodegradable material. In an embodiment, the pin and the lock may be formed from a soluble or biodegradable material. It is noted that any combination of the housing, the base, the pin, or the lock (or part of the lock thereof) may be formed from a soluble or biodegradable material.

In an embodiment, the soluble or biodegradable material may be a water soluble material. In an embodiment, the water soluble may be one or more materials selected from polyvinyl alcohol; acetylated polyvinyl alcohol; polyvinylpyrrolidone; polyethylene oxide; gelatin, sulfate-, carbonate-, and/or citrate-substituted polyvinyl alcohols, polyvinylpyrrolidones, polyalkylene oxides, acrylamides, cellulose esters, cellulose ethers, cellulose amides, cellulose and derivatives thereof (such as hydroxypropyl methylcellulose), polyvinyl acetates, polycarboxylic acids and salts thereof, polyamino acids or peptides, polyamides, polyacrylamides, copolymers of maleic acid and acrylic acid, copolymers of acrylamides and (meth)acrylic acid, polysaccharides, or a combination of two or more thereof. In an embodiment, the security device may further comprise one or more of a radio frequency identification device or electronic article surveillance system.

Disclosed is a method of using a security device. In an embodiment, the security device may be attached to an article. The security device may be attached to an article by, for example, a pin traversing the article and being secured therethrough by its releasable attachment to a base on one side and locking attachment to a cap (or housing) via a locking mechanism and/or locking insert on its other side. The security device may be removed from the article. The security device may be removed from the article by, for example, breaking or releasing the pin from the base at a release point, wherein the pin may detach into the locking insert and/or cap and remain therein. All of a portion of the security device may exposed to a solution, wherein at least one component of the security device may be soluble or degradable in the solution. In an embodiment, the solution may be water. In an embodiment, the at least one component of the security device that is soluble or degradable may be water soluble.

In an embodiment, the cap and locking insert housing the pin may be exposed to a solution. In an embodiment, the base may be exposed to a solution. In an embodiment, one or more of the cap, locking insert, pin, or base may be soluble or degradable in the solution. It is noted that any combination of the cap, the base, the pin, or the locking insert (or part of the locking insert thereof) may be soluble or degradable in the solution. In an embodiment, the pin may be soluble or degradable in the solution. In an embodiment, the pin and locking insert (or part of the locking insert thereof) may be soluble or degradable in the solution. In an embodiment, in addition to the pin and/or locking insert being soluble or degradable in the solution or independently of their solubility or insolubility, the base may be soluble or degradable in the solution. In an embodiment, at least one component of the security device may be reused in a new security device. In an embodiment, the cap may be reused in a new security device. In an embodiment, the cap and/or locking insert may be reused in a new (or second) security device. In an embodiment, the cap and/or locking insert may be reused in a new (or second) security device with a new pin releasably attached to a new base. In an embodiment, the pin and/or base of the original (or first) security device may be discarded, disposed of, or recycled by exposure and to the solution and dissolving of the pin and the base (in whole, in part, or substantially thereof).

These and other aspects and embodiments of the present technology are further understood and described in the Detailed Description that follows. It is noted that any combination of the foregoing is contemplated herein.

### DESCRIPTION OF THE DRAWINGS

The present teachings may be better understood by reference to the following detailed description taken in connection with the following illustrations, wherein:

FIG. 1 is a side view of an embodiment of a hard tag in an engaged position;

FIG. 2 is a cross-sectional side view of an embodiment of a hard tag in an engaged position;

FIG. 3 is an exploded view of an embodiment of a hard tag;

FIG. 4 is an exploded, cross-sectional view of an embodiment of a hard tag;

FIG. 5 is an exploded view of another embodiment of a hard tag;

FIG. 6 is an exploded, bottom view of another embodiment of a hard tag;

FIG. 7 is an exploded, top view of another embodiment of a hard tag;

FIG. 8 is a top view of an embodiment of a hard tag and instructional sheet;

FIG. 9 is a perspective view of an embodiment of a bug sled with hook;

FIG. 10 is a top view of an embodiment of a bug sled with hook;

FIG. 11 is a side view of an embodiment of a bug sled with hook;

FIG. 12 is a perspective view of an embodiment of a corner bug sled;

FIG. 13 is a perspective view of an embodiment of a corner bug sled;

FIG. 14 is a top view of an embodiment of a corner bug sled;

FIG. 15 is a side view of an embodiment of a corner bug sled;

FIG. 16 is a perspective view of an embodiment of a bug sled; and

FIG. 17 is a top view of an embodiment of a bug sled.

### DETAILED DESCRIPTION

Reference will now be made in detail to embodiments of the present teachings, examples of which are illustrated in the accompanying drawings. It is to be understood that other embodiments may be utilized and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

A single use hard tag is described herein. In an embodiment, the single use hard tag may be removable by the consumer after purchase and prior to wear. In one embodiment, components of the single use hard tag are soluble, biodegradable, or otherwise recyclable. For example, a portion of the single use hard tag may be water soluble under certain conditions. That is one or more of the components that form the tag construction are provided such that is soluble in water. In an example, the entire single use hard tag, i.e., each component forming the hard tag structure, may be water soluble under certain conditions. The single use hard tag may be removable by a release point on the pin at the base, wherein the pin remains locked in locking mechanism even after removal. The used single use hard tag, i.e., a single use hard tag after it has been removed from a garment and after the pin is released or broken from the base, may be submerged in its soluble counterpart (in one example, water) and under solubility conditions (e.g., temperature, pressure, and the like), or put under its biodegradable conditions, so as to facilitate the solubility or biodegradability of the single use hard tag's soluble and/or biodegradable components. Any portions of the single use hard tag that are not soluble or biodegradable, if any, may then be recycled, reused, or the like. For example, any portions of the single use hard tag that are not soluble or biodegradable, if any, may then be reused with a new and unused soluble or biodegradable component.

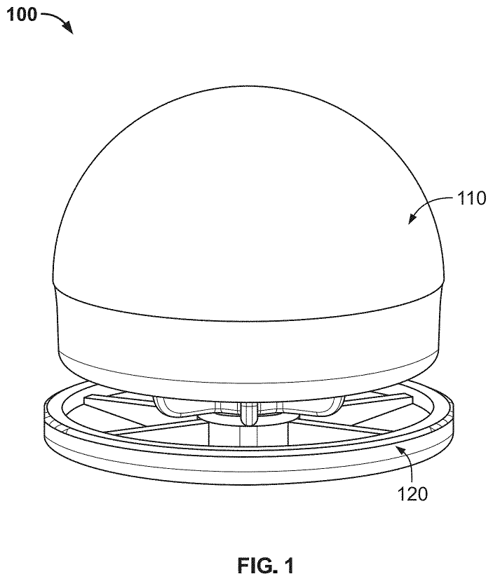

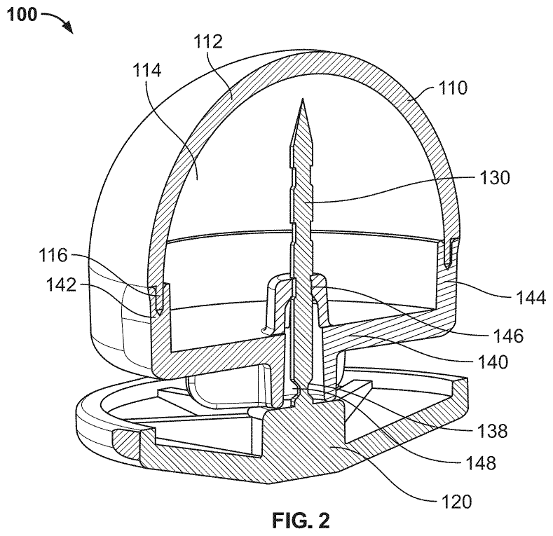

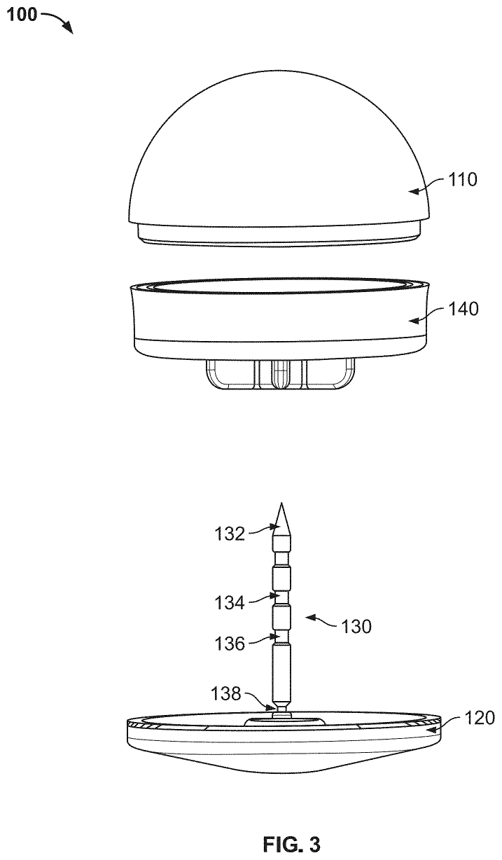

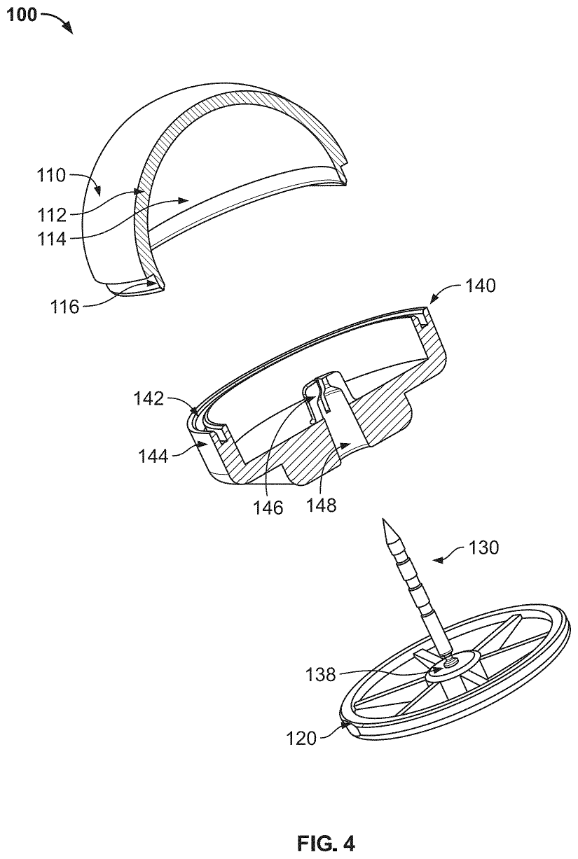

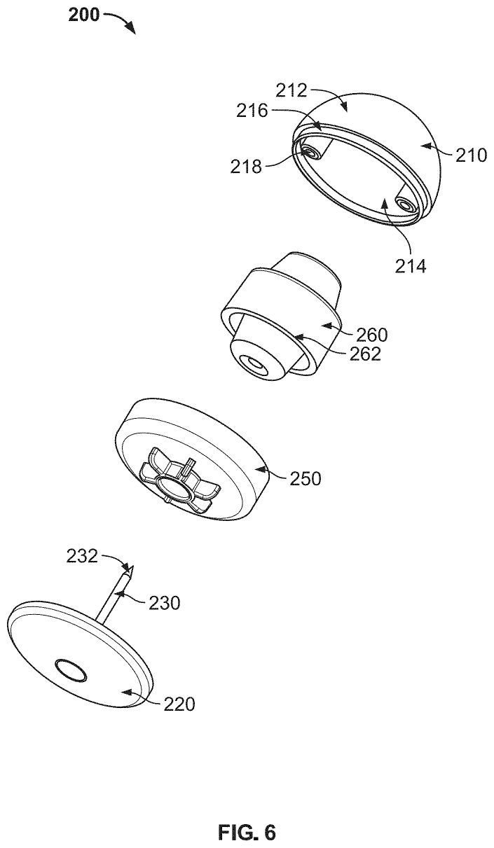

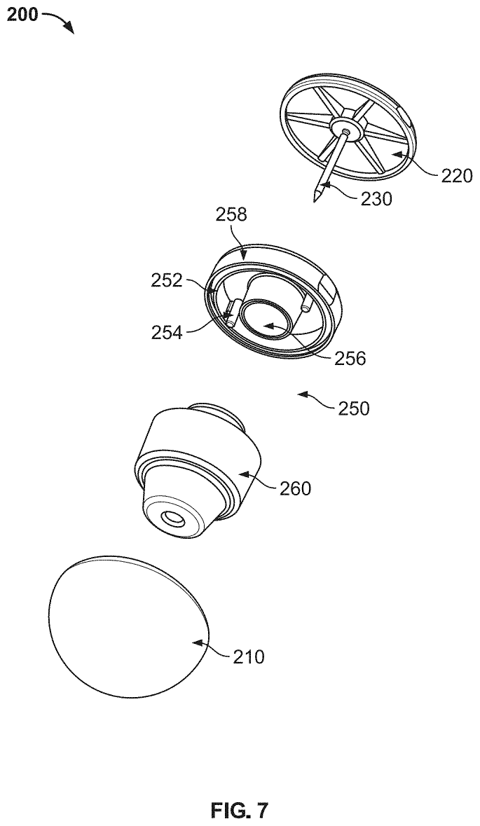

FIG. 1 illustrates a single use hard tag 100. The single use hard tag 100 may generally comprise a cap 110 and a base 120. The cap 110 and the base 120 may also be referred to as a first body and a second body. In an embodiment, the cap and 110 and base 120 may affix to each side of a product or other merchandise, such as, for example, a garment, shoe, towel, bedding, other fabric item, etc. As shown in FIGS. 2-7, the single use hard tag 100 may further comprise a locking mechanism, such as a pin 130 and a locking insert 140. In an embodiment, the pin 130 may be releasably attached to the base 120, traverse the product, and lock into the locking insert 140, where the locking insert 140 is attached to the cap 110. The cap 110 and locking insert 140 as they are attached may also be referred to as a first body where the base is a second body. In an embodiment, the single use hard tag 100 may facilitate vertical or straight application of the pin through the product and into the locking insert 140 so as to avoid damage to the product during application, use, or removal of the single use hard tag 100, including snagging or marking of the product. The single use hard tag 100 may generally be secured to any portion of a product and may be applied in-store at a retail location, at the manufacturing facility or warehouse, or at any point prior to the point of sale including at the point of sale.

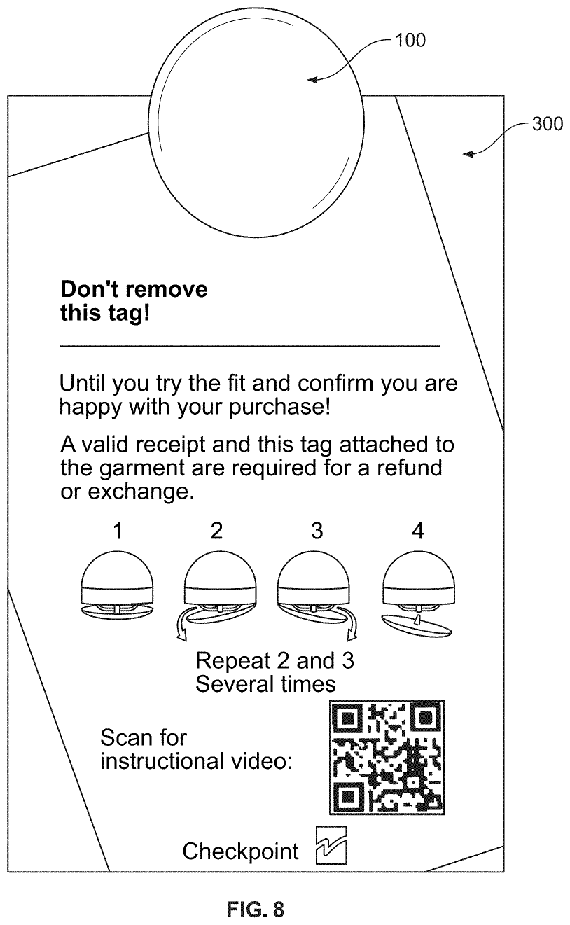

Once secured to a product and placed in an engaged or locked position, wherein the pin 130 is locked into the locking insert 140, the single use hard tag 100 may remain affixed to the product until removed. The single use hard tag 100 may further include and secure an instructional label 300 to the product detailing removal of the single use hard tag 100, see FIG. 8. In an embodiment, removal of the single use hard tag 100 may include turning and pulling the base 120, or otherwise applying force between the base 120 and the cap 110, until the pin 130 breaks or releases from its position attached to the base. In an embodiment, the hard tag 100 may not be able to be reattached to a product or placed back into an engaged or locked position after removal from that position. As a result, the presence or absence of the single use hard tag 100 on a product may be used to indicate whether an item has been used or worn and whether the item is thereby returnable under store policy. Although applicable to any product or merchandise where returns of unused products is desirable, the single use hard tag 100 may be useful for dresses, special occasion wear, menswear, formalwear for men and women, lingerie, undergarments, swimwear, shoes, towels, bedding, online and catalog orders, and the like.

In an embodiment, the single use hard tag 100 may not include any EAS component or RFID component. In an embodiment, the single use hard tag 100 may house an EAS component and/or RFID component, or otherwise combine with a tag housing either or both of these components. The EAS component and/or RFID component may be removed at the point of sale or may be deactivated at the point of sale. These components may provide asset tracking capabilities and/or deter theft by alarming under certain triggering events that may be associated with theft.

The cap 110 of the single use hard tag 100 may include an exterior wall 112 and a hollow core 114. The exterior wall 112 may be of any suitable shape, including rounded, squared, tapered, elongated, and the like. The hollow core 114 may be large enough to accommodate the pin 130 when in an engaged or locked position, as shown in FIG. 2 for example. In an embodiment, the cap 110 may include an engagement feature 116 that corresponds to and engages with an engagement feature 142 of the locking insert 140. In an example, the cap 110 may include a protrusion 116 that corresponds to and inserts into a recess 142 of the locking insert 140. The engagement may be snap fit, friction fit, pressure fit, or the like, and may include an adhesive or bonding material. In another embodiment, the cap 110 and locking insert 140 may be continuously formed.

The locking insert 140 may include an exterior wall 144 and hollow interior that, together with the exterior wall 112 and hollow core 114 of the cap 110, forms a hollow cavity in the single use hard tag 100. The locking insert 140 may further comprise a lock 146 and a detachment member 148. The lock 146 may interlock or engage with one or more recesses 134, 136 of the pin 130. The one or more recesses 134, 136 of the pin 130 may be used to accommodate products of various thicknesses and to ensure a proper and secure fit of the single use hard tag 100 when in a locked position. The pin 130 may be shaped so as to facilitate insertion of the pin 130 into the locking insert 140, but to prevent removal of the pin 130 from the locking insert 140 once the pin 130 has already been inserted. The pin 130 may further include a point or tapered end 132 to facilitate attachment through or into a portion of a product, such as a fabric, without causing stress or damage to the material. The detachment member 148 may interact with a release point 138 of the pin 130. The release point 138 of the pin 130 may facilitate transition of the single use hard tag 100 from an engaged or locked position, to an unengaged or unlocked position (i.e. a broken or used position) by breaking at the release point 138 upon pressure or turning of the base 120 from the cap 110 and locking insert 140. When disengaged, the pin 130 may remain in the cap 110 such that the consumer is never in contact with the pin 130, which may otherwise cause injury if exposed.

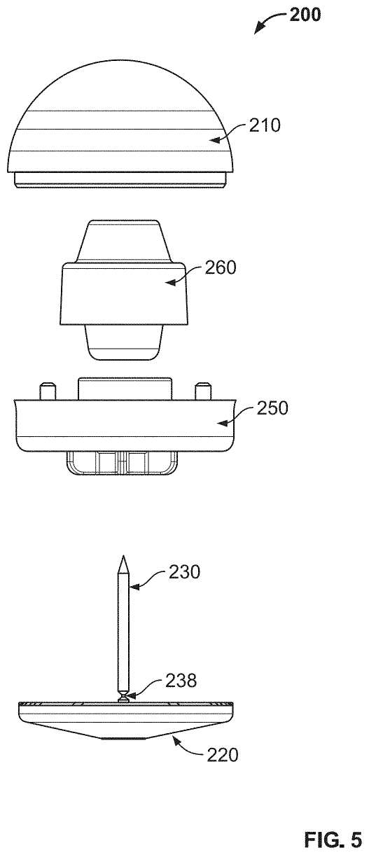

As shown in FIGS. 2-4, the single use hard tag 100 may comprise a locking insert 140, wherein the lock 146 and exterior wall that attaches to the cap 110 are formed continuously. As shown in FIGS. 5-7, these may also be formed as two components. For example, an embodiment of a single use hard tag 200 may include a cap 210, a base 220, a pin 230, a support 250, and a lock 260. The cap 210 of the single use hard tag 200 may include an exterior wall 212 and a hollow core 214. The exterior wall 212 may be of any suitable shape, including rounded, squared, tapered, elongated, and the like. The hollow core 214 may be large enough to accommodate the pin 230 when in an engaged or locked position. In an embodiment, the cap 210 may include engagement features 216, 218 that correspond to and engage with engagement features 252, 254 of the support 250. In an example, the cap 210 may include a protrusion 216 that corresponds to and inserts into a recess 252 of the support 250. In an example, the cap 210 may include a receiving portion 218 that corresponds to and receives a protrusion 254 of the support 250. The engagement of receiving portion 218 and protrusion 254 may prevent rotation of the cap 210 on the support 250. The engagements may be snap fit, friction fit, pressure fit, or the like, and may include an adhesive or bonding material.

The support 250 may include an exterior wall 258 and hollow interior that, together with the exterior wall 212 and hollow core 214 of the cap 210, forms a hollow cavity in the single use hard tag 200. The support 250 may further include a lip 256 that inserts and attaches to a collar 262 of the lock 260. The lock 260 may include biased engagement members that engage and secure the pin 230 in the lock 260. The pin 230 may be shaped so as to facilitate insertion of the pin 230 into the lock 260, but to prevent removal of the pin 230 from the lock 260 once the pin 230 has already been inserted. The pin 230 may further include a point or tapered end 232 to facilitate attachment through or into a portion of a product, such as a fabric, without causing stress or damage to the material. The lock 260 and/or support 250 may further include a detachment member. The detachment member may interact with a release point 238 of the pin 230. The release point 238 of the pin 230 may facilitate transition of the single use hard tag 100 from an engaged or locked position, to an unengaged or unlocked position (i.e. a broken or used position) by breaking at the release point 238 upon pressure or turning of the base 220 from the cap 210 and support 250. When disengaged, the pin 230 may remain in the cap 210 such that the consumer is never in contact with the pin 230, which may otherwise cause injury if exposed.

It will be appreciated that the hard tag is not limited to the tag configuration of FIGS. 1-8. The hard tag of FIGS. 1-8 is shown for purposes of demonstrating aspects of the invention. The hard tag need not be of a locking pin type configuration. Rather, it will be appreciated that the structure, configuration, and locking mechanism of the tag are not particularly limited and can be selected as desired for a particular purpose or intended application. Further, which components of the tag are provided as water soluble can be selected as desired. In embodiments, any component that is not reusable and will be discarded can be provided or formed from a water soluble material.

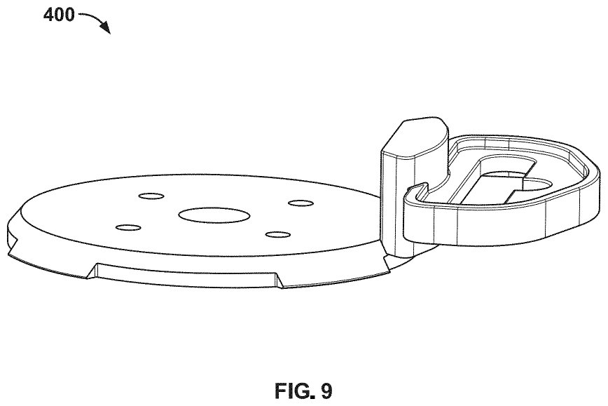

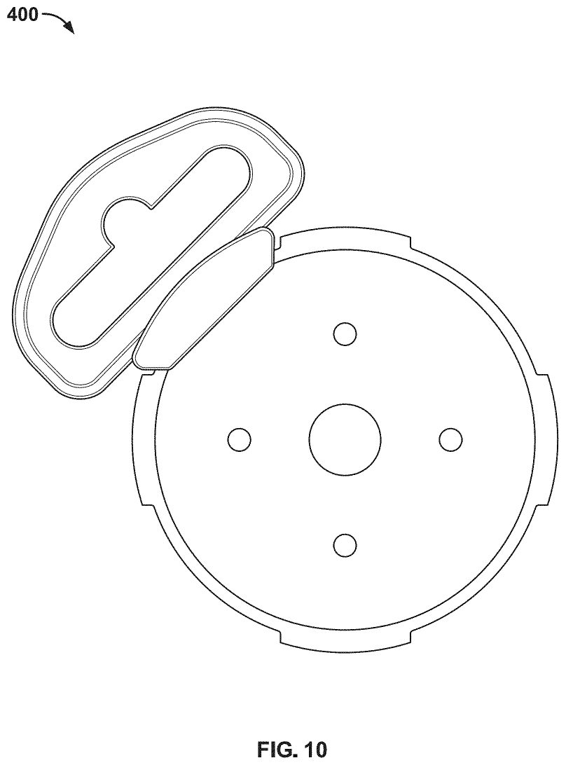

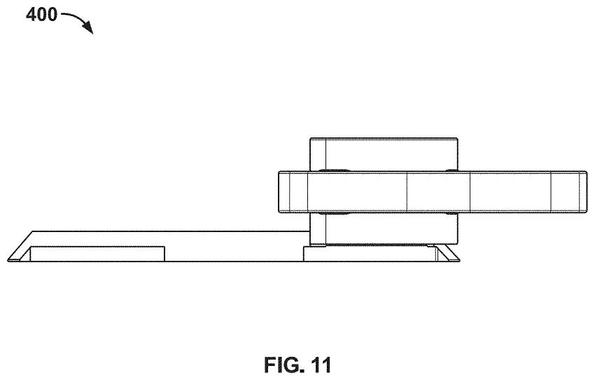

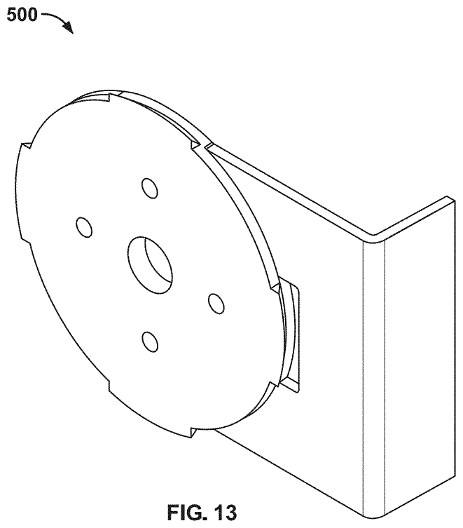

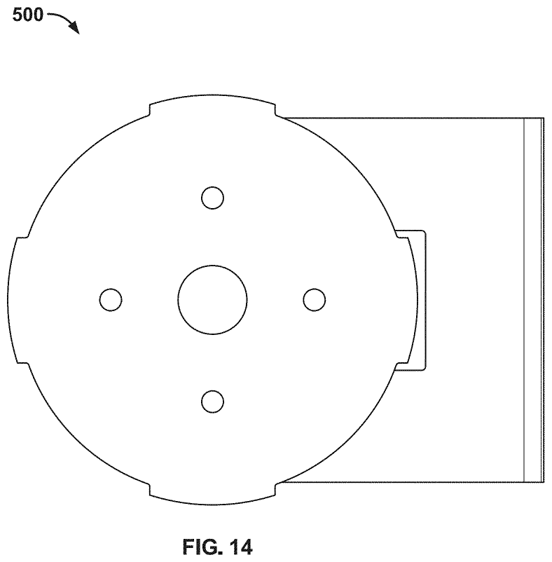

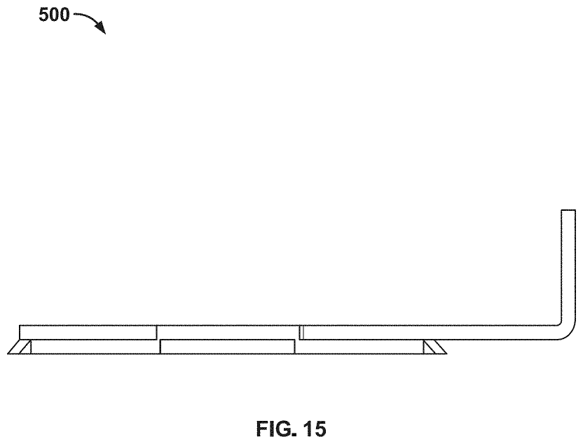

FIGS. 9-17 illustrate a component of a locking sled type hard tag, and which can be formed from a water soluble material. According to various example embodiments, an example locking sled security device is provided that includes a tag that securely attaches to a product via an attachment sled that is affixed to the product. FIGS. 9-17 illustrate an example of an attachment sled component for such a locking sled security device. The tag may include a wireless signal transmitting device that can be detected by an antenna of an electronic article surveillance (EAS) system located at, for example, an exit of a retail establishment to indicate that the item to which the security device is attached is being stolen or otherwise improperly removed from a location. The tag may be removable from the sled through the use of a prescribed detacher key (e.g., a magnetic key) at a point of sale in a retail establishment during a transaction to purchase the product. More specifically, according to some example embodiments, an example security device may include tag and sled components. The sled may be affixed, via an adhesive, to a product to be protected. The tag may then be removably locked to the sled to provide security to the product. To lock the tag to the sled, the tag may be configured to receive a tab of the sled into a receiving recess of the tag. Upon receiving the tab of the sled into the receiving recess of the tag, the tag may be rotated, by a user, relative to the sled such that the tab of the sled travels from the receiving recess of the tag into a locking channel of the tag. As the tab enters the locking channel, the tab of the sled may engage the locking channel, and more specifically a lower lip of the locking channel, thereby preventing the tag from being lifted away from the sled without rotating the tab back to the receiving recess.

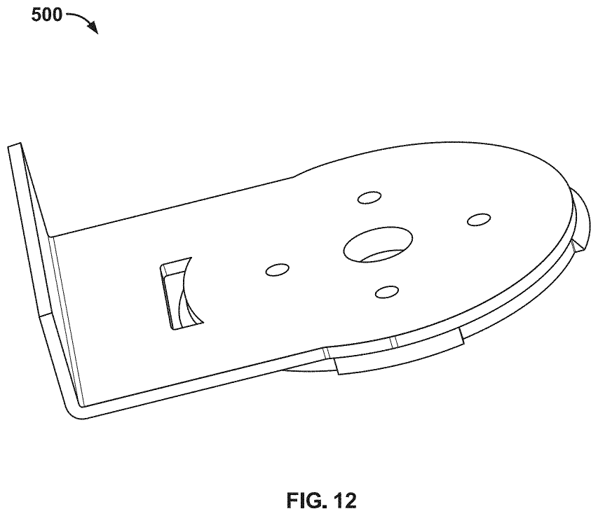

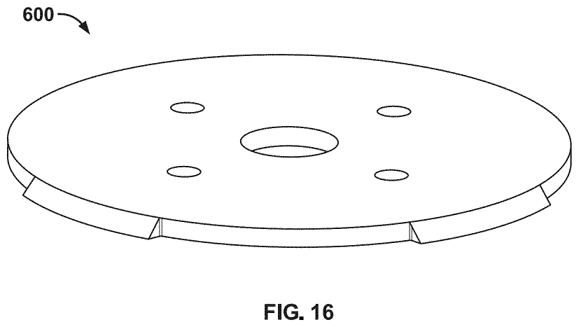

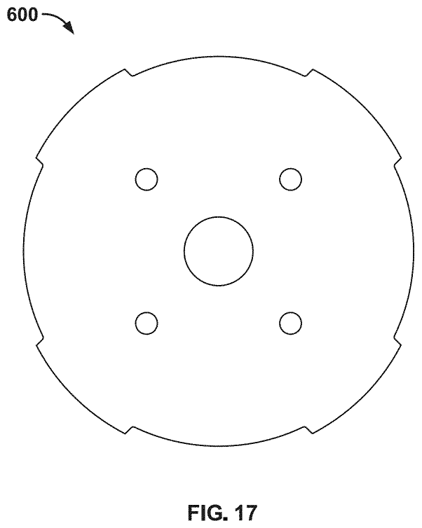

FIGS. 9-11 show various views of a sled component 400 with hanging tag or hook that may be produced with water soluble materials. FIGS. 12-15 show various views of a corner sled component 500 that may be produced with water soluble materials. FIGS. 16-17 show various views of a sled component 600 that may be produced with water soluble materials. The sled components are typically disposable components. Being disposable, the sled components may be formed from a water soluble material in accordance with the present technology to avoid creating excess waste when the tag has served its useful life.

One or more of the components forming the hard tag can be formed from a water soluble material. In one embodiment, all the components forming the hard tag can be formed from a water soluble material. For example, referring to the single use hard tag 100 in FIGS. 1-4, all components may be comprised of a water soluble material, including the cap 110, base 120, pin 130, and locking insert 140. In another embodiment, at least one component, but fewer than all the components can be formed from a water soluble material. For example, it may be desirable to recycle components for reuse in constructing new products. Using the single use hard tag 200 as an example, all or at least one component may be comprised of a water soluble material as described herein, including the cap 210, base 220, pin 230, support 250, and lock 260. In an example, the pin 230, base 220, and the lock 260 may be comprised of soluble materials and as the locking and release mechanism during use may be “irreversible” (to indicated, in an example, removal of the single use hard tag by a consumer). In an example, the cap 210 and support 250 may be comprised of insoluble materials and may be recycled and reused in subsequent single use hard tags. It is noted that none of these embodiments are particularly limiting and that any of the components of the single use hard tag 100, 200 may be soluble or insoluble in various embodiments as may be desired, including all or none of the components being soluble.

A used single use hard tag, i.e., a single use hard tag after it has been removed from a garment and after the pin is released or broken from the base, may be submerged in its soluble counterpart (in one example, water) and under solubility conditions (e.g., temperature, pressure, and the like), or put under its biodegradable conditions, so as to facilitate the solubility or biodegradability of the single use hard tag's soluble and/or biodegradable components. Any portions of the single use hard tag that are not soluble or biodegradable, if any, may then be recycled, reused, or the like. For example, any portions of the single use hard tag that are not soluble or biodegradable, if any, may then be reused with a new and unused soluble or biodegradable component. In an example, the pin and base, where the pin is releasably attached to the base and where the pin is thereby released or broken from the base, may be comprised of soluble or biodegradable materials because the pin's attachment to the base and release thereof may not be reversible (and instead the unlocking mechanism or release mechanism is “irreversible”). The cap, support, and similar, may be reused, and may be made of either or both soluble or biodegradable materials.

In an embodiment, an attached single use hard tag, i.e., a single use hard tag that is locked in place on a garment, may be submerged in its soluble counterpart (in one example, water) and under solubility conditions (e.g., temperature, pressure, and the like), to facilitate the removal of the single use hard tag from the garment (as opposed to releasably breaking the pin from the base). In this embodiment, the unlocking mechanism or solubility of the locking components is also considered “irreversible” and would indicate whether the single use hard tag has been removed by a consumer. In this embodiment, it may be beneficial that the item to which the single use hard tag is attached, is not sensitive to water soluble counterpart is needed to facilitate solubility and removal of the single use hard tag. For example, the single use hard tag could be attached to a swim suit and the soluble components of the single use hard tag could be soluble in water. Clothing and fabrics generally, may not be sensitive to water so that proper removal of an attached single use hard tag through facilitated solubility of its components may be accomplished without damage to the underlying item.

In an embodiment, the respective components for the single use hard tags may be formed by any suitable method, including, for example, injection molding, as is suitable for forming a shaped structure from the material selected to form the component part. As described above, the components can be formed of an appropriate water soluble material or a water insoluble material as desired for a particular purpose or intended application.

In an embodiment, one or more of the components of the single use hard tag 100, 200 may be biodegradable, compostable, and/or non-toxic. As described herein, one or more components in the hard tags are formed from a material that is soluble in water. The water soluble material is not particularly limited and can be selected as desired for a particular purpose or intended application. The water soluble material can comprise a polymer, a copolymer, or mixtures thereof. Examples of suitable water soluble materials include, but are not limited to, one or more materials selected from polyvinyl alcohol; acetylated polyvinyl alcohol; polyvinylpyrrolidone; polyethylene oxide; gelatin, sulfate-, carbonate-, and/or citrate-substituted polyvinyl alcohols, polyvinylpyrrolidones, polyalkylene oxides, acrylamides, cellulose esters, cellulose ethers, cellulose amides, cellulose and derivatives thereof (such as hydroxypropyl methylcellulose), polyvinyl acetates, polycarboxylic acids and salts thereof, polyamino acids or peptides, polyamides, polyacrylamides, copolymers of maleic acid and acrylic acid, copolymers of acrylamides and (meth)acrylic acid, polysaccharides, etc. An exemplary water soluble material is a polyvinyl alcohol.

The water soluble material may be formulated or provided such that the conditions under which it is soluble are selected as desired for a particular purpose or intended application. For example, the water soluble material may be “cold water” soluble such that it is soluble in water of a relatively low temperature, e.g., water with a temperature below room temperature (e.g., below about 20° C.). In one embodiment, the water soluble material is soluble in water at temperatures between about 5° C. to about 15° C., or from about 5° C. to about 10° C. In another embodiment, the water soluble material employed in the forming the components can be formed from a material that is soluble in water around room temperature, e.g., is soluble in water at a temperature of from about 20° C. to about 25° C. In another embodiment, the water soluble material may be insoluble in cold water or room temperature water and be soluble in warm or hot water having a temperature of, for example, 30° C., 40° C., 50° C., 60° C., or higher. In one embodiment, the water soluble material is soluble in water having a temperature of from about 30° C. to about 100° C., from about 40° C. to about 90° C., or from about 50° C. to about 75° C. In one embodiment, the water soluble material is soluble in water having a temperature of from about 50° C. to about 70° C.

In an embodiment, the higher the water temperature, the faster the solubility. Solubility may further be affected by thickness of the component, agitation or vibratory action applied to the water/dissolving media, and water volume, in addition to the family of materials as described above. Regarding thickness, components with thinner tolerances will likely exhibit faster solubility of the single use hard tags. Agitating the water and employing higher volumes of water may also increase the solubility of the materials or the time for materials to dissolve.

Where components of the hard tag are formed from non-soluble materials, the non-soluble components may be formed from any suitable material including, but not limited to, plastics and polymers such as polycarbonate; acrylonitrile butadiene styrene (ABS) (C8H8C4H6C3H3N); polycarbonate or acrylonitrile butadiene styrene alloys (PC-ABS); polybutylene terephthalate (PBT); polyethylene terephthalate (PET); polyphenylene oxide (PPO); polyphenylene sulfide (PPS); polyphenylene ether; modified polyphenylene ether containing polystyrene; liquid crystal polymers; polystyrene; styrene-acrylonitrile copolymer; rubber-reinforced polystyrene; poly ether ketone (PEEK); acrylic resins such as polymers and copolymers of alkyl esters of acrylic and methacrylic acid styrene-methyl methacrylate copolymer; styrene-methyl methacrylate-butadiene copolymer; polymethyl methacrylate; methyl methacrylate-styrene copolymer; polyvinyl acetate; polysulfone; polyether sulfone; polyether imide; polyarylate; polyamideimide; polyvinyl chloride; vinyl chloride-ethylene copolymer; vinyl chloride-vinyl acetate copolymer; polyimides, polyamides; polyolefins such as polyethylene; ultra high molecular weight polyethylene; high density polyethylene; linear low density polyethylene; polyethylene napthalate; polyethylene terephthalate; polypropylene; chlorinated polyethylene; ethylene acrylic acid copolymers; polyamides, for example, nylon 6, nylon 6,6, and the like; phenylene oxide resins; phenylene sulfide resins; polyoxymethylenes; polyesters; polyvinyl chloride; vinylidene chloride/vinyl chloride resins; and vinyl aromatic resins such as poly(vinylnaphthalene); polystyrene; poly(vinyltoluene); polyimides; polyaryletheretherketone; polyphthalamide; polyetheretherketones; polyaryletherketone, and combinations of two or more thereof. It will be appreciated that components such as the pin can be formed from suitable metal parts or plated metal parts.

Other examples of suitable materials may include, but are not limited to, rubber-like polymers including, polyisoprene, butadiene rubbers, styrene-butadiene copolymers, such as Buna S and SBR, cis —polybutadiene, cis —polyisoprene, nitrile elastomers or NBR rubbers (also known as acrylonitrile and butadiene copolymers) such as Buna N, butyl rubbers including copolymers of isobutylene and isoprene, ethylene-propylene monomer (EDM), ethylene-propylene-diene monomer (EPDM), neoprene (polychloroprene), polysulfide rubbers (thiokols), ethylene-propylene rubbers (RPDM), urethane elastomers, and silicone rubbers such as dimethysilanediol polymers and polydimethyl siloxane, fluoroelastomer, polyacrylate elastomer, polyethylene (chlorinated, chlorosulfonated), styrene-isoprene-styrene (SIS), styrene-butadiene-styrene (SBS), EPDM-polypropylene blend, and combinations of two or more thereof. What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A security device comprising a tag, the tag comprising a first body engageable with a second body via a locking mechanism, wherein at least one of the first body, the second body, a part of the locking mechanism, or the whole locking mechanism is formed from a soluble or biodegradable material.

2. The security device of claim 1, wherein the locking mechanism comprises a pin and locking insert configured to receive the pin.

3. The security device of claim 1, wherein at least a part of the locking mechanism is formed from material that is not soluble or biodegradable.

4. The security device of claim 1, wherein at least a part of the locking mechanism is formed from a soluble or biodegradable material.

5. The security device of claim 1, wherein the locking mechanism comprises a locking sled.

6. The security device of claim 5, wherein the locking sled is formed from a soluble or biodegradable material.

7. The security device of claim 1, wherein the soluble or biodegradable material is a water soluble material.

8. The security device of claim 7, wherein the water soluble material may be one or more materials selected from polyvinyl alcohol; acetylated polyvinyl alcohol; polyvinylpyrrolidone; polyethylene oxide; gelatin, sulfate-, carbonate-, and/or citrate-substituted polyvinyl alcohols, polyvinylpyrrolidones, polyalkylene oxides, acrylamides, cellulose esters, cellulose ethers, cellulose amides, cellulose and derivatives thereof (such as hydroxypropyl methylcellulose), polyvinyl acetates, polycarboxylic acids and salts thereof, polyamino acids or peptides, polyamides, polyacrylamides, copolymers of maleic acid and acrylic acid, copolymers of acrylamides and (meth)acrylic acid, polysaccharides, or a combination of two or more thereof.

9. The security device of claim 8, wherein the water soluble material is soluble in water having a temperature of from about 5° C. to about 100° C.

10. The security device of claim 8, wherein the water soluble material is soluble in water having a temperature of from about 5° C. to about 15° C.

11. The security device of claim 8, wherein the water soluble material is soluble in water having a temperature of from about 20° C. to about 25° C.

12. The security device of claim 8, wherein the water soluble material is soluble in water having a temperature of from about 50° C. to about 70° C.

13. The security device of claim 1 further comprising one or more of a radio frequency identification device or electronic article surveillance system.

14. A single use, water soluble hard tag, comprising:
a housing enclosing a hollow cavity,
a base, and
a lock,
wherein the lock is positioned in the hollow cavity and operatively configured to receive and secure a pin,
wherein the pin is releasably attached to the base, and
wherein one or more of the housing, the base, the pin, or the lock are formed from a soluble or biodegradable material.

15. The security device of claim 14, wherein the pin is formed from a soluble or biodegradable material.

16. The security device of claim 14, wherein the soluble or biodegradable material is a water soluble material.

17. The security device of claim 16, wherein the water soluble may be one or more materials selected from polyvinyl alcohol; acetylated polyvinyl alcohol; polyvinylpyrrolidone; polyethylene oxide; gelatin, sulfate-, carbonate-, and/or citrate-substituted polyvinyl alcohols, polyvinylpyrrolidones, polyalkylene oxides, acrylamides, cellulose esters, cellulose ethers, cellulose amides, cellulose and derivatives thereof (such as hydroxypropyl methylcellulose), polyvinyl acetates, polycarboxylic acids and salts thereof, polyamino acids or peptides, polyamides, polyacrylamides, copolymers of maleic acid and acrylic acid, copolymers of acrylamides and (meth)acrylic acid, polysaccharides, or a combination of two or more thereof.

18. The security device of claim 14 further comprising one or more of a radio frequency identification device or electronic article surveillance system.

19. A method of using a security device of claim 1 wherein the security device is attached to an article, the security device is removed from the article, and the security device is exposed to a solution, wherein at least one component of the security device is soluble or degradable in the solution.

20. The method of claim 19, wherein the at least one component of the security device that is soluble or degradable is made from a water soluble material.
